(19) United States
(12) Patent Application Publication
(10) Pub. No.: US 2006/0216978 A1
(43) Pub. Date: Sep. 28, 2006

(54) Electrical connector capable of interrupting an ESD path

(75) Inventors: Chin-Yuan Lin, Tai-Chung City (TW); Yi-Kai Lin, Hsinchu City (TW); Sheng-Lee Lin, Beipu Township (TW)

Correspondence Address: BIRCH STEWART KOLASCH & BIRCH, PO BOX 747, FALLS CHURCH, VA, 22040-0747, US

(73) Assignee: Avision Inc., Hsinchu (TW)

(21) Appl. No.: 11/372,266

(22) Filed: Mar. 10, 2006

(30) Foreign Application Priority Data
Mar. 10, 2005 (TW) 094107313

(51) Int. Cl. H01R 3/00

(52) U.S. Cl. 439/164

(57) ABSTRACT

An electrical connector, which is to be electrically connected to an electrical apparatus and capable of interrupting an ESD path, includes a body, a column and an insulation medium. The body has a through hole. The column passes through the through hole. The invention utilizes the insulation medium to encapsulate the column such that the insulation medium can contact the through hole to prevent the ESD path from passing through the through hole.

### BACKGROUND OF THE INVENTION

1. Field of the Invention

The invention relates to an electrical connector capable of interrupting an ESD (ElectroStatic Discharge) path, and more particularly to an electrical connector using an insulation medium to interrupt an ESD path.

2. Description of the Related Art

Electrical connectors are widely used in computers and computer peripheral apparatuses such as scanners and printers. In order to prevent the signal transmitted through the electrical connector from being interfered by electrostatic charges on the human hands, the electrical connectors must have the capability of the ESD protection.

FIG. 1 is a pictorial view showing a conventional electrical connector 100. FIG. 2 is a side view showing the connector of FIG. 1. Referring to FIGS. 1 and 2, the electrical connector 100 includes a body 110 and a bolt 120. The body 110 has a through hole 112 and the bolt 120 passes through the through hole 112. When the electrical connector 100 is screwed to a circuit board (not shown) tightly, a gap, through which an ESD path passes, still exists between the bolt 120 and the through hole 112. Thus, the electrostatic charges may interfere with the signal transmission of the electrical connector.

The conventional ESD protection methods may be found in, for example, U.S. Pat. Nos. 5,256,074 and 5,674,083, and Taiwan Patent Publication Nos. 443613, 435845 and 403263. In these methods, the electrostatic charges are canalled to the ground such that the electrostatic charges are eliminated. These ESD protection methods need a good electrostatic charge canalling path, and the ESD damage may occur if an improper contact exists.

### SUMMARY OF THE INVENTION

It is therefore an object of the invention to provide an electrical connector using an insulation medium to interrupt an ESD (ElectroStatic Discharge) path so as to achieve the ESD protection in a low-cost and effective manner.

To achieve the above-identified object, the invention provides an electrical connector to be electrically connected to an electrical apparatus. The connector includes a body having a through hole, a column passing through the through hole, and an insulation medium for encapsulating the column and thus contacting the through hole to prevent an ESD (ElectroStatic Discharge) path from passing through the through hole.

Thus, when the electrical connector is screwed to a circuit board tightly, the insulation medium can fill a gap between the column and the through hole so as to interrupt the ESD path.

### BRIEF DESCRIPTION OF THE DRAWINGS

FIG. 1 is a pictorial view showing a conventional electrical connector.

FIG. 2 is a side view showing the connector of FIG. 1.

FIG. 3 is a pictorial view showing an electrical connector according to a first embodiment of the invention.

FIG. 4 is a side view showing the connector of FIG. 3.

FIG. 5 is a side view showing an electrical connector according to a second embodiment of the invention.

FIG. 6 is a side view showing an electrical connector according to a third embodiment of the invention.

FIG. 7 is a side view showing an electrical connector according to a fourth embodiment of the invention.

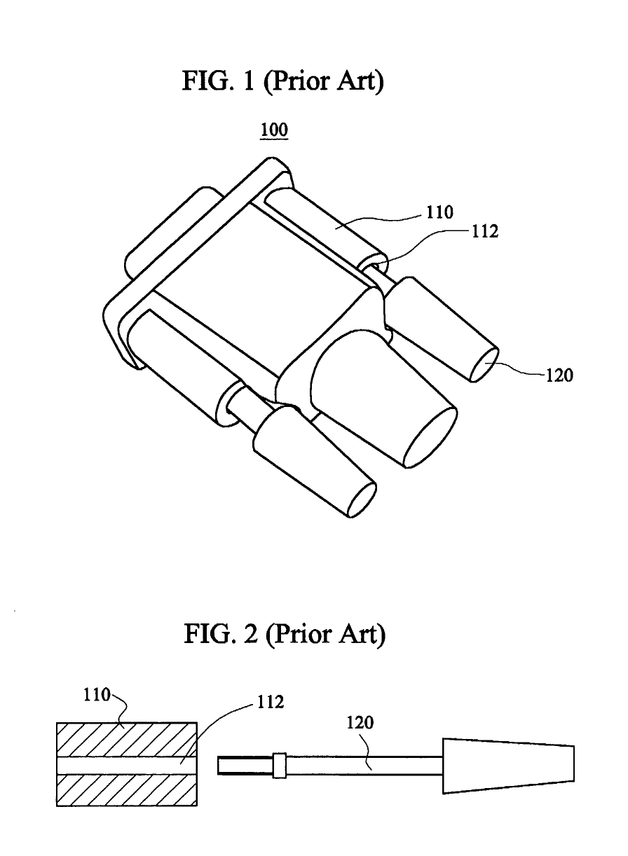

### DETAILED DESCRIPTION OF THE INVENTION

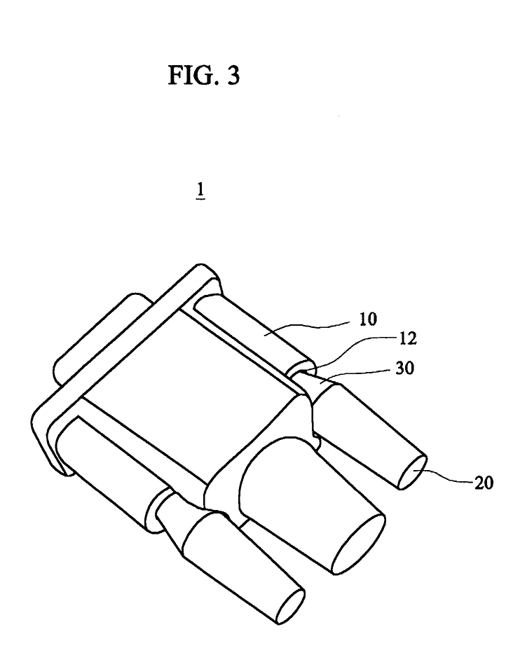

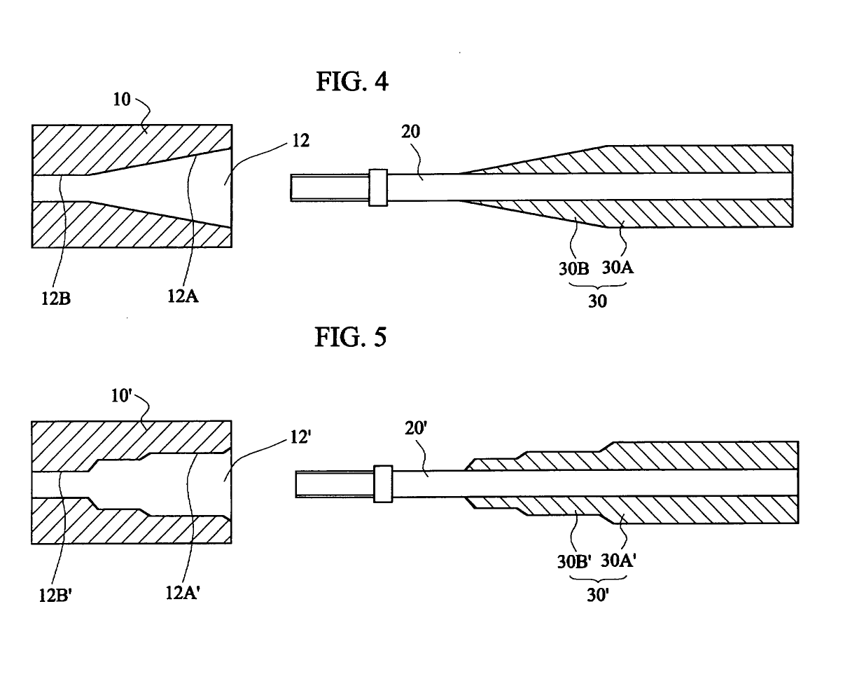

FIG. 3 is a pictorial view showing an electrical connector 1 according to a first embodiment of the invention. FIG. 4 is a side view showing the connector of FIG. 3. Referring to FIGS. 3 and 4, the electrical connector 1 of this embodiment capable of interrupting an ESD (ElectroStatic Discharge) path is to be electrically connected to an electrical apparatus and includes a body 10, a column 20 and an insulation medium 30. The electrical apparatus may be, for example, a computer, a scanner, a multi-function peripheral, or the like. The body 10 has a through hole 12. The through hole 12 has a first part 12A with a first inner diameter and a second part 12B with a second inner diameter smaller than the first inner diameter. The first and second parts 12A and 12B respectively accommodate the column 20 with a smaller outer diameter and the insulation medium 30, which encapsulates the column 20 and has a larger outer diameter. The first part 12A may conveniently guide the column 20 to pass through the through hole 12. It is to be noted that the tapered first part 12A may also be regarded as a part having a plurality of different inner diameters. That is, the inner diameter of the first part 12A gradually decreases from the right-hand side to the left-hand side. Thus, although the first part 12A of FIG. 4 is a tapered part, it is also possible to integrate the first part 12A with the second part 12B to form a completely tapered hole in the body 10. In this case, the through hole 12 may also be regarded as a hole having a first part with a first inner diameter and a second part with a second inner diameter smaller than the first inner diameter. In another embodiment, the through hole 12 may have a constant inner diameter, and the effect of the invention still can be achieved through the insulation medium 30 for encapsulating the column 20.

In this embodiment, the column 20 passing through the through hole 12 is typically a bolt with a male thread or a female thread. The tapered insulation medium 30 has a first section 30A with a first outer diameter and a second section 30B with a second outer diameter. The insulation medium 30 encapsulates the column 20 and may contact the first part 12A of the through hole 12 so as to prevent the ESD path from passing through the through hole 12. Thus, when the column 20 is screwed to the circuit board tightly, the insulation medium 30 is tightly pressed between the through hole 12 and the column 20 to form the encapsulation structure capable of preventing the electrostatic charges from passing therethrough.

FIG. 5 is a side view showing an electrical connector according to a second embodiment of the invention. As shown in FIG. 5, an insulation medium 30′ of this embodiment is similar to the insulation medium 30 of the first embodiment except that the insulation medium 30′ is a ladder-like medium. Thus, the insulation medium 30′ has a first section 30A′ with a first outer diameter and a second section 30B′ with a second outer diameter smaller than the first outer diameter, and the column 20′ is a cylinder. A through hole 12′ of a body 10′ has a first part 12A′ and a second part 12B′ to fit to the insulation medium 30′.

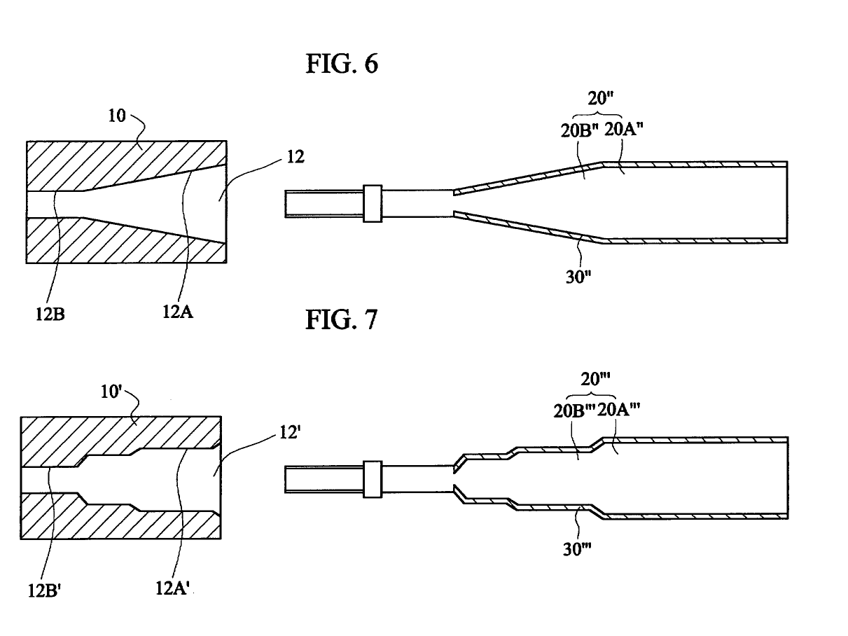

FIG. 6 is a side view showing an electrical connector 20″ according to a third embodiment of the invention. As shown in FIG. 6, the column 20″ of this embodiment is a tapered column, and an insulation medium 30″ is only an encapsulating layer without losing the effect of interrupting the ESD path. Thus, the column 20″ may be regarded as a first section 20A″ with a first outer diameter and a second section 20B″ with a second outer diameter smaller that the first outer diameter, and the insulation medium 30″ encapsulates the first section 20A″ and the second section 20B″.

FIG. 7 is a side view showing an electrical connector 20′″ according to a fourth embodiment of the invention. As shown in FIG. 7, this embodiment is similar to the second embodiment except that the column 20′″ is a ladder-like column and an insulation medium 30′″ is only an encapsulating layer without losing the effect of interrupting the ESD path. Thus, the column 20′″ may be regarded as a first section 20A′″ with a first outer diameter and a second section 20B′″ with a second outer diameter smaller than the first outer diameter, and the insulation medium 30′″ encapsulates the first section 20A′″ and the second section 20B′″.

Each of the insulation media of all the embodiments may be a flexible encapsulation medium, which may be a plastic tube, a rubber tube or a heat shrinkable tube directly encapsulating the column, and may also be a plastic medium directly molded on the column by way of injection molding. The column may be an electrical insulating column formed after an anode treatment (non-conductive treatment).

According to the above-mentioned structure of the invention, the ESD path may be effectively interrupted when the electrical connector is screwed to the circuit board tightly, such that the signal transmission is free from being interfered. After the experimental verification, the electrical connector of the invention can withstand the electrostatic charges of 25 KV, which cannot be achieved in the prior art.

While the invention has been described by way of examples and in terms of preferred embodiments, it is to be understood that the invention is not limited to the disclosed embodiments. To the contrary, it is intended to cover various modifications. Therefore, the scope of the appended claims should be accorded the broadest interpretation so as to encompass all such modifications.

What is claimed is:

1. An electrical connector to be electrically connected to an electrical apparatus, the connector comprising:
a body having a through hole;
a column passing through the through hole; and
an insulation medium for encapsulating the column and thus contacting the through hole to prevent an ESD (ElectroStatic Discharge) path from passing through the through hole.

2. The connector according to claim 1, wherein the through hole has a first part with a first inner diameter and a second part with a second inner diameter smaller than the first inner diameter.

3. The connector according to claim 2, wherein the insulation medium contacts the first part of the through hole.

4. The connector according to claim 1, wherein the column is a tapered column or a ladder-like column.

5. The connector according to claim 1, wherein the insulation medium is a tapered column or a ladder-like column.

6. The connector according to claim 1, wherein the column has a first section with a first outer diameter and a second section with a second outer diameter smaller than the first outer diameter, and the insulation medium encapsulates the first section and the second section.

7. The connector according to claim 1, wherein the insulation medium has a first section with a first outer diameter and a second section with a second outer diameter smaller than the first outer diameter.

8. The connector according to claim 1, wherein the insulation medium is a plastic tube, a rubber tube or a heat shrinkable tube.

9. The connector according to claim 1, wherein the insulation medium is a plastic medium directly molded on the column by way of injection molding.

10. The connector according to claim 1, wherein the column is an electrical insulating column.
